(19) United States
(12) Patent Application Publication
(10) Pub. No.: US 2006/0041027 A1
(43) Pub. Date: Feb. 23, 2006

(54) Antifoam compositions containing fatty and rosin acids or derivatives thereof

(76) Inventors: Gerald W. Heebner, Savannah, GA (US); Mack Arthur Richbrug JR., Savannah, GA (US)

Correspondence Address: INTERNATIONAL PAPER COMPANY, 6285 TRI-RIDGE BOULEVARD, LOVELAND, OH, 45140, US

(21) Appl. No.: 11/199,430

(22) Filed: Aug. 8, 2005

Related U.S. Application Data
(60) Provisional application No. 60/599,459, filed on Aug. 6, 2004.

(51) Int. Cl. B01D 19/02

(52) U.S. Cl. 516/115

(57) ABSTRACT

The invention relates to compositions that are capable of preventing foam from forming in media as well as methods of making and using the same.

The present application claims the benefit of priority under 35 USC § 119(e) to U.S. Provisional Patent Application 60/599,459, which is hereby incorporated, in its entirety, herein by reference.

### FIELD OF THE INVENTION

The invention relates to compositions that are capable of preventing foam from forming in media as well as methods of making and using the same.

### BACKGROUND OF THE INVENTION

The processes related to the mining and/or refining and/or benefication and/or acidulation of mineral and/or rock and/or ore causes the production of a foam. Traditionally, an aqueous media containing the mineral and/or rock and/or ore is present during processes related mining and/or refining and/or beneficiating and/or acidulation of the same. Foam control and/or minimization during these processes, especially during acidulation steps, leads to multiple problems. Examples of such problems include corrosion, scaling and diminished heat transfer, as well as cavitation and overflow. Such problems result in loss of production and/or operational efficiencies.

To solve such problems, one has been known to use antifoam agents. Examples of an antifoam agent are those mentioned in U.S. Pat. No. 4,083,939, which is hereby incorporated, in its entirety, herein by reference. U.S. Pat. No. 4,083,939 relates to the use of tributoxyethylphosphate compounds as antifoaming agents, especially during the evaporative crystallization of calcined trona solutions. However, the use of tributoxyethylphosphate as an antifoaming agent of mineral, rock and/or ore is very costly and/or is not environmentally friendly. A further antifoam composition for processes related to trona ore mining and/or refining is found in U.S. patent application Ser. No. ______ filed on Aug. 8, 2005, and also claiming the benefit of priority under 35 USC § 19(e) to U.S. Provisional Patent Application 60/599,459. U.S. patent application Ser. No. ______ filed on Aug. 8, 2005, is hereby incorporated, in its entirety, herein by reference.

Others have attempted to control stable foam in the beneficiation of phosphate rock. One example is that described in U.S. Pat. No. 5,858,214, which is hereby incorporated, in its entirety, herein by reference which relates to the use of synthetic and/or semi-synthetic polymer formulations as antifoams. However, such synthetic and/or semi-synthetic polymers may be not cost effective and/or environment-friendly. Phosphate rock and/or ore mining, refining and/or beneficiation is one example of mineral, rock, and/or ore mining. It is well known that Phosphate rock and/or ore mining and refining causes foam production. Examples of Phosphate rock and/or ore mining and refining processes can be found in U.S. Pat. Nos. 6,149,013; 5,858,214; 5,500,193; 5,435,893; 4,737,273; and 4,828,811, which are hereby incorporated, in their entirety, herein by reference.

Downstream from phosphate rock beneficiation, predominantly during the production of fertilizers and other production processes that utilize the products of phosphate rock beneficiation is phosphoric acid production. In many instances, phosphoric acid is produced from beneficiated phosphoric rock utilizing a wet-process. During this process, the gases such as carbon dioxide are produced in an aqueous media within, in part, an highly exothermic acidulation step. These gases form foam in the acidulation process which is very undesirable by causing slow and low efficiency operational difficulties, such as cavitation and overflowing. Examples of the acidulation of phosphate rock to produce phosphoric acid can be found in U.S. Pat. Nos. 6,562,308; 6,562,308; 4,258,008; 4,258,007; 4,220,630; 4,196,172; 4,136,151; 4,132,760; 4,083,936; and 4,001,383, which are hereby incorporated, in their entirety, herein by reference

To date, a low cost, environment-friendly antifoaming composition from renewable resources for use in the processes related to mining and/or refining of minerals, rock, and/or ore, such as phosphate rock and/or ore, is desired.

### SUMMARY OF THE INVENTION

One object of the invention is a composition containing the product of contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrite compounds of these acids based upon the total weight of the mixture. A still further aspect of the invention is when the mixture contains not more than 60 wt % of unsaponifiable material based upon the total weight of the mixture. An embodiment of the invention is when the foam containing water is at a pH that is less than 7. Yet, an additional embodiment is when the mixture may further contain water. An additional embodiment is when the mixture is a soap that is at least partially soluble therein a hydrophilic solvent and has a pH of not less than about 7. Still, a further embodiment of the invention is when the mixture contains an organic solvent to form a partial or full solution thereof at any pH. An embodiment of this object of the invention relates to when the residues of distillation of natural oils are extracted from at least one member selected from the group consisting of resinous trees, vegetables, and tallow. An embodiment of this object of the invention relates to when there is a partial or full dispersion, emulsion, suspension, or sol of tall oil pitch, tall oil, crude tail oil, monomer, distilled tall oil, or mixtures thereof contacted with a foam containing water.

Another object of the invention relates to instances when the above-mentioned mixture contains particles. One aspect of this invention is when the particles have a size in at least one dimension ranging from 1 nm to 100 microns on average.

Another object of the invention relates to when the above-mentioned mixture contains from 50 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture; from 0.2 to 30 wt % of at least one rosin acid compound selected from the group consisting of natural resin-based acids obtained from residues of distillation of natural oils, amine carboxylates and ester and nitrile compounds of these acids based upon the total weight of the mixture; and not more than 20 wt % of unsaponifiable material based upon the total weight of the mixture.

Another object of the invention relates to when the above-mentioned mixture the contains a combination of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof, and at least one rosin acid compound selected from the group consisting of natural resin-based acids obtained from residues of distillation of natural oils, amine carboxylates and ester and nitrile compounds of these acids at an amount ranging from 80 to 99.9 wt % based upon the total weight of the mixture; and from 0.1 to 15 wt % of unsaponifiable material based upon the total weight of the mixture.

An additional object of the invention is a composition containing the product of contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture. A still further aspect of the invention is when the mixture contains not more than 60 wt % of unsaponifiable material based upon the total weight of the mixture. An additional embodiment relates to instances when the composition contains a sodium salt. An additional embodiment of the invention is when the mixture is at a pH of from 7 to 10 and/or from about 7.5 to about 9.5. Yet, another embodiment relates to instances when the partial or full foam containing water further contains an inorganic salt. Yet, another embodiment relates to instances when the partial or full foam containing water further contains a phosphorus-containing compound, a phosphoric acid.

An additional object of the invention is a composition containing the product of contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture. A still further aspect of the invention is when the mixture contains not more than 60 wt % of unsaponifiable material based upon the total weight of the mixture. An additional embodiment relates to instances when the mixture contains a lower alkyl alcohol or a poly(lower alkyl)ol, poly(lower alkyl) glycol or mixtures thereof.

One object of the invention is a method of making a composition by contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture. A still further aspect of the invention is when the mixture contains not more than 60 wt % of unsaponifiable material based upon the total weight of the mixture.

One object of the invention is a method of inhibiting, reducing, and/or preventing the presence of foam in a media by contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture. A still further aspect of the invention is when the mixture contains not more than 60 wt % of unsaponifiable material based upon the total weight of the mixture. An embodiment of the invention is when the foam containing water is at a pH that is less than 7. Yet, an additional embodiment is when the mixture may further contain water. An additional embodiment is when the mixture is a soap that is at least partially soluble therein a hydrophilic solvent and has a pH of not less than about 7. Still, a further embodiment of the invention is when the mixture contains an organic solvent to form a partial or full solution thereof at any pH. An embodiment of this object of the invention relates to when the residues of distillation of natural oils are extracted from at least one member selected from the group consisting of resinous trees, vegetables, and tallow. An embodiment of this object of the invention relates to when there is a partial or full dispersion, emulsion, suspension, or sol of tall oil pitch, tall oil, crude tail oil, monomer, distilled tall oil, or mixtures thereof contacted with a foam containing water. An additional aspect of the invention is the above-mentioned method where the amount of foam present in the media is reduced by at least 5% relative to the amount of foam present otherwise and/or before the contacting occurs.

One object of the invention is a method of inhibiting, reducing, and/or preventing the presence of foam in a media by contacting a partial or full foam comprising water with a mixture containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture. An addition aspect of the invention is when the composition contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture. A still further aspect of the invention is when the mixture contains not more than 60 wt % of unsaponifiable material based upon the total weight of the mixture. The foam containing water may contain a phosphorus-containing compound, phosphoric acid. In an additional aspect of the invention, the method may further include refining phosphorus-containing rock, preferably after beneficiating the same, and more preferably wet-processing and production of phosphoric acid. In another embodiment of the invention, the contacting and the refining are performed concurrently.

Another object of the invention is a composition, containing a mixture, a phosphorus-containing compound; and water. In an embodiment of the invention, the mixture contains from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle. In another embodiment, the mixture contains from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle. In another embodiment, the mixture contains not more than 60 wt % of unsaponifiable material based upon the total weight of the particle. In another embodiment of the invention, the mixture is a partial or full dispersion, suspension, sol, emulsion, or mixtures thereof. In an additional embodiment, the composition is a partial foam. In yet an additional aspect of the invention, the phosphorus-containing compound is phosphoric acid and/or phosphoric rock. In an additional embodiment, the composition contains gypsum. In an additional embodiment, the composition contains a strong acid.

### BRIEF DESCRIPTION OF THE DRAWINGS

FIG. 1: One embodiment of the invention that demonstrates the antifoam effect of the composition according to the invention.

FIG. 2: A bar graph demonstrating that 100% and 10% of the active composition according to the invention has very good antifoam capabilities as compared to an isopropyl alcohol (IPA) control.

FIG. 3: A bar graph demonstrating that different amounts of the reagent, especially when the reagent is in the form of a soap according to the invention has very good antifoam capabilities as compared to an isopropyl alcohol (IPA) control.

FIG. 4: A line graph demonstrating that low amounts of the reagent, especially when the reagent is in the form of a soap according to the invention has very good antifoam capabilities as compared to a control when nothing is added.

FIG. 5: A line graph demonstrating the pH effect and the dose response as a function thereof the antifoam composition.

FIG. 6: A line graph demonstrating the temperature effect and the dose response as a function thereof the antifoam composition.

FIG. 7: A line graph demonstrating the pH effect and the dose response as a function thereof the antifoam composition at 45° C.

FIG. 8: A line graph demonstrating the pH effect, dose effect and multiple compositions' responses thereto as antifoam capabilities.

FIG. 9: A line graph demonstrating the pH effect thereon the antifoam composition at 85° C.

### DETAILED DESCRIPTION OF THE INVENTION

This application is related to the fields of chemistry and colloidal sciences which is described, for example, in Robert J. Hunter's “Introduction to Modern Colloid Science” (1993), Oxford University Press, which is which is hereby incorporated, in its entirety, herein by reference.

This application is related to the fields of mining mineral, rock an/or ore which is described, for example, in Kirk-Othmer “Encyclopedia of Chemical Technology”, fourth edition (1996), John Wiley & Sons, which is which is hereby incorporated, in its entirety, herein by reference.

The inventors have surprisingly found a composition that is relatively low cost and environmental friendly for use as an antifoam in aqueous media. This composition is a renewable resource and is especially suitable for use in the mining and/or refining of minerals, rock, and/or ore.

The composition comprises biomass and/or byproducts thereof. Thus, the composition is a renewable resource.

Biomass products, such as those byproducts of refining and processes taking advantage of natural sources are usually low cost. Examples of a biomass product may be the byproducts of paper making from trees. Accordingly, biomass products, such as those similar to black liquor solids, soaps, skimmings, as well as tall oil products such as pitch and/or distillate products thereof are examples of such biomass products. Further, such biomass products are predominantly environment friendly, especially compared to those traditional antifoaming agents utilized it the above-mentioned mining and/or refining processes.

The present invention relates to a composition containing at least one saturated or unsaturated, monocarboxylic aliphatic hydrocarbon. The saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof. Since the hydrocarbon is monocarboxylic, the derivative may be any commonly known derivative of a carbonyl-containing compound known in general Organic Chemistry Textbooks, such as “Organic Chemistry”, 5th Edition, by Leroy G. Wade, which is which is hereby incorporated, in its entirety, herein by reference.

Examples of derivatives of the saturated or unsaturated, monocarboxylic aliphatic hydrocarbon may be an ester, nitrile, or amine carboxylate thereof, as well as those commonly found in black liquor solids, soaps, skimmings, as well as tall oil products such as pitch and/or distillate products thereof. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof having a linear, branched, and/or cyclic chain. Again, the saturated or unsaturated, monocarboxylic aliphatic hydrocarbon may have from 5 to 30 carbon atoms, preferably from 8 to 24 carbon atoms. The hydrocarbon may have 5, 6, 7, 8, 9, 10, 11, 12, 13, 14, 15, 16, 17, 18, 19, 20, 21, 22, 23, 24, 25, 26, 27, 28, 29, and 30 carbon atoms, including any and all ranges and subranges therein.

The present invention relates to a composition containing at least one saturated or unsaturated, monocarboxylic aliphatic hydrocarbon or derivative thereof having a linear, branched, and/or cyclic chain, a dimer thereof, a trimer thereof, or mixtures thereof. The composition may contain from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition. If the saturated or unsaturated, monocarboxylic aliphatic hydrocarbon or derivative thereof having a linear, branched, and/or cyclic chain, a dimer thereof, a trimer thereof, or mixtures thereof is part of an antifoam composition, then the antifoam composition from 0.1 to 99.9 wt % saturated or unsaturated, monocarboxylic aliphatic hydrocarbon or derivative thereof having a linear, branched, and/or cyclic chain, a dimer thereof, a trimer thereof, or mixtures thereof based upon the total weight of the composition as well.

The amount of saturated or unsaturated, monocarboxylic aliphatic hydrocarbon or derivative thereof having a linear, branched, and/or cyclic chain, a dimer thereof, a trimer thereof, or mixtures thereof present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition. This is so even in instances where the saturated or unsaturated, monocarboxylic aliphatic hydrocarbon or derivative thereof having a linear, branched, and/or cyclic chain, a dimer thereof, a trimer thereof, or mixtures thereof is present in an antifoam composition.

The saturated or unsaturated, monocarboxylic aliphatic hydrocarbon or derivative thereof having a linear, branched, and/or cyclic chain, a dimer thereof, a trimer thereof, may be any one or more found in biomass products, such as those similar to black liquor solids, soaps, skimmings, as well as tall oil products such as pitch and/or distillate products such as tall oil fatty acid, distilled tall oil, crude tall oil, and monomer.

The saturated or unsaturated, monocarboxylic aliphatic hydrocarbon is a fatty acid. Examples of such include oleic, linoliec and/or stearic acids, including a derivative thereof; a linear, branched, and/or cyclic isomer thereof; a dimer thereof; and/or a trimer thereof.

The saturated or unsaturated, monocarboxylic aliphatic hydrocarbon or derivative thereof having a linear, branched, and/or cyclic chain, a dimer thereof, a trimer thereof, may be an acid having linear, branched, and/or cyclic C₁₈ chain. Examples of such may include linoliec and/or oleic acids or derivative thereof. Further examples may be linear, branched, and/or cyclic isomers of linoliec and/or oleic acids.

Examples of the saturated or unsaturated, monocarboxylic aliphatic hydrocarbon or derivative thereof having a linear, branched, and/or cyclic chain, a dimer thereof, a trimer thereof may be those found and described, for example in U.S. Pat. Nos. 6,875,842; 6,846,941; 6,344,573; 6,414,111; 4,519,952; and 6,623,554, which are hereby incorporated, in their entirety, herein by reference.

Finally, examples of the saturated or unsaturated, monocarboxylic aliphatic hydrocarbon or derivative thereof having a linear, branched, and/or cyclic chain, a dimer thereof, a trimer thereof may be caproic, enthanic, caprylic, capric, isodecyl, pelargonic, lauric, myristic, palmitic, oleic, linoleic, linolenic, stearic, isostearic, behenic, arachidic, arachidonic, erucic, azelaic, coconut, soya, tall oil, tallow, lard, neatsfoot, apricot, wheat germ, corn oil, cotton seed oil, ricinic, ricinoleic, rapeseed, palm kernel fatty acids, dimer acids, trimer acids, ozone acids, diacids, triacids, combinations and mixtures of these.

The present invention relates to a composition containing at least one rosin acid compound. The rosin acid compound may be selected from those natural resin-based acids, such as those obtained from residues of distillation of natural oils. The rosin acid compound may be also be derived. Since the rosin compound is an acid, the derivative may be any commonly known derivative of a carbonyl-containing compound known in general Organic Chemistry Textbooks, such as “Organic Chemistry”, 5th Edition, by Leroy G. Wade. Examples of such derivatives include, but is not limited to esters, amine carboxylates, and nitrile derivative of the rosin acid compound.

The rosin acids may include those that may be isolated from black liquor skimmings, crude tall oil, tall oil pitch, and distilled tall oil. In addition rosin acids may be those found in tall oil rosin, gum rosin and wood rosin. These naturally occurring rosins may be suitably mixtures and/or isomers of monocarboxylic tricyclic rosin acids usually containing 20 carbon atoms. The tricyclic rosin acids differ mainly in the position of the double bonds. The rosin acid may be at least one of levopimaric acid, neoabietic acid, palustric acid, abietic acid, dehydroabietic acid, seco-dehydroabietic acid, tetrahydroabietic acid, dihydroabietic acid, pimaric acid, paulstric acid, and isopimaric acid, or mixtures, isomers, and/or derivatives thereof. The rosins derived from natural sources also include rosins, i.e. rosin mixtures, modified notably by polymerisation, isomerisation, disproportionation and hydrogenation. The rosin acids may include those mentioned in U.S. Pat. Nos. 6,875,842; 6,846,941; 6,344,573; 6,414,111; 4,519,952; and 6,623,554, which are hereby incorporated, in their entirety, herein by reference.

The composition may contain from 0.1 to 99.9 wt % one rosin acid compound selected from the group consisting of natural resin-based acids obtained from residues of distillation of natural oils, amine carboxylates and ester and nitrile compounds of these acids based upon the total weight of the composition. If the one rosin acid compound selected from the group consisting of natural resin-based acids obtained from residues of distillation of natural oils, amine carboxylates and ester and nitrile compounds of these acids is part of an antifoam composition, then the antifoam composition from 0.1 to 99.9 wt % rosin acid compound selected from the group consisting of natural resin-based acids obtained from residues of distillation of natural oils, amine carboxylates and ester and nitrile compounds of these acids based upon the total weight of the composition as well.

The amount of rosin acid compound selected from the group consisting of natural resin-based acids obtained from residues of distillation of natural oils, amine carboxylates and ester and nitrile compounds of these acids present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, 75, 80, 85, 90, 95, 96, 97, 98, 99, 99.1, 99.2, 99.3, 99.4, 99.5, 99.6, 99.7, 99.8, and 99.9 wt % based upon the total weight of the composition. This is so even in instances where the rosin acid compound selected from the group consisting of natural resin-based acids obtained from residues of distillation of natural oils, amine carboxylates and ester and nitrile compounds of these acids.

The present invention relates to a composition containing at least one unsaponifiable material. Examples of unsaponifiable materials is found, but not limited to, those described in U.S. Pat. Nos. 6,465,665; 6,462,210; and 6,297,353 which are hereby incorporated, in their entirety, herein by reference. Unsaponifiable material may be any neutral material that is not capable of being saponified, or ester thereof.

Examples of the unsaponifiable components include, but are not limited to, tocopherols, tocotrienols, carotenoids, vitamin A, vitamin K, vitamin D, lipoproteins, cholesterol, provitamins, growth factors, flavonoids, sterols, stilbenes, squalane, oryzanol and lycopene. Unsaponifiable material may include those mentioned in U.S. Pat. Nos. 6,875,842; 6,846,941; 6,344,573; 6,414,111; 4,519,952; and 6,623,554, which are hereby incorporated, in their entirety, herein by reference.

Further examples of such unsaponifiable materials are those found in plants, such as woody plants, preferably trees. Examples of such include, but are not limited to sterols, stanols, polycosanols, 3,5-sitostadiene-3-ona, 4-stigmasten-3-ona, α- and/or β-sitosterols, α- and/or β sitostanols, Campestanol, Campesterol, Cycloartenol, Docosanol, Eicosanol, Ergosterol, Escualene, Fatty alcohol esters, Sterol esters, Hexacosanol, Methyleneycloartenol, Pimaral, Pimarol, Stigmasta-3-ona, Tetracosanol, etc.

The present invention relates to a composition containing not more than 75 wt % of unsaponifiable material based upon the total weight of the composition. If the unsaponifiable material is part of an antifoam composition, then the antifoam composition contains not more than 75 wt % unsaponifiable material based upon the total weight of the composition as well. The amount of unsaponifiable material present in the composition may be 0.1, 0.2, 0.3, 0.5, 1.0, 1.5, 2.0, 3.0, 4.0, 5.0, 10, 15, 20, 25, 30, 35, 40, 45, 50, 55, 60, 65, 70, and 75 wt % based upon the total weight of the composition. This is so even in instances where the unsaponifiable material is present in an antifoam composition.

The composition may have any pH from 1 to 14, including 1, 2, 3, 4, 5, 6, 7, 8, 9, 10, 11, 12, 13, and 14, including any and all ranges and subranges therebetween. Preferably, the composition is an antifoam composition at a pH of not less than about 7, more preferably about 7 to 10, most preferably from about 7.5 to about 9.5. The pH may preferably be 7.1, 7.2, 7.4, 7.5, 7.6, 7.8, 8.0, 8.2, 8.5, 8.6, 8.8, 9.0, 9.1, 9.2, 9.3, 9.4, 9.5, 9.7, and 10, including any and all ranges and subranges therebetween.

The composition may have an acid value. Preferably acid values include those greater than 10, including greater than or equal to 10, 11, 12, 13, 14, 15, 20, 25, 30, 35, 40, 45, 50, 55, 60, 65, 70, 75, 80, 85, 90, 95, 100, 105, 110, 120, 125, 130, 140, 150, 160, 170, 180, 190, and 200, including any and all ranges and subranges therebetween. Preferably, the acid value of the composition is greater than or equal to 40.

Preferably, the composition of the present invention is an antifoam composition containing from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the composition; from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the composition; and not more than 60 wt % of at least one unsaponifiable material based upon the total weight of the composition. All ranges and subranges within those amounts disclosed above may be utilized.

When the composition contains at least one of the hydrocarbon, rosin acid, and/or unsaponifiable material, preferably each may be from the residues of distillation of natural oils. Preferable those natural oils that are extracted from resinous trees, vegetables, and/or tallow. More preferably, the source of the hydrocarbon, rosin acid, and/or unsaponifiable material is tall oil pitch, tall oil, crude tail oil, monomer, distilled tall oil, or mixtures thereof.

The composition may include a solvent. The solvent may be a hydrophilic solvent, such as water, and/or a hydrophobic solvent and/or an organic solvent. When the composition includes the hydrophilic solvent, it is preferable that the hydrocarbon, rosin acid, and unsaponifiable material be in the form of a soap that is at least partially soluble therein and has a pH of no less than 7. The mixture of the hydrocarbon, rosin acid, and unsaponifiable material may be solid, semisolid, liquid, or mixtures thereof. The mixture may be in any state, except that of a 100% gaseous state. If the mixture is a solid and/or semisolid and/or liquid, it may be, in part, in the form of a particle. The particle size may have any size in any axis. Preferably, the particle may be from about 0.01 nm to about 100 microns, more preferably from about 0.1 nm to about 10 microns, and most preferably from about 1 nm from 1 to 1000 nm along at least one axis. The particle may be 1, 2, 3, 4, 5, 10, 1, 5, 20, 25, 30, 35, 40, 45, 50, 55, 60, 65, 70, 75, 80, 85, 90, 100, 125, 150, 175, 200, 250, 300, 350, 400, 450, 500, 550, 600, 650, 700, 750, 800, 850, 900, 950, and 1000 nm along at least one axis. When a plurality of particles exists, the above size in any axis may be the average size in any axis.

When the composition is includes an organic solvent, the pH of the composition may be any pH and the mixture of the hydrocarbon, rosin acid, and unsaponifiable material may be partially or fully solubilized therein. Preferably, the mixture of the hydrocarbon, rosin acid, and unsaponifiable material is either fully solubilized therein the organic solvent or a partial suspension, dispersion, emulsion, or sol therewith.

In addition, the hydrocarbon, rosin acid, and unsaponifiable material mixture may be a colloid. The mixture may be hydrophobic or hydrophilic or mixtures thereof, preferably hydrophobic. Still further, the mixture may be a discontinuous phase in contact with a continuous phase, preferably being the hydrophilic, hydrophobic and/or organic solvent. The combination of the mixture and the continuous phase may form a full and/or partial solution, suspension, dispersion, emulsion, or sol.

When the composition is a full and/or partial solution, suspension, dispersion, emulsion, or sol, the mixture and/or particle may be present from 1-100 wt % by weight in solution. The amount of mixture in the suspension, dispersion, emulsion, or sol may be 1, 2, 5, 10, 15, 20, 25, 30, 35, 40, 45, 50, 55, 60, 65, 70, 75, 80, 85, 90, 95, and 100% by weight, including any and all ranges and subranges therein.

The composition of the present invention may contain at least one base. While any base is feasible, preferably bases include sodium, potassium or ammonium-containing bases. Specific examples my include hydroxides of sodium, potassium or ammonium. When the base is added to the composition, at least a portion of the resultant ions from the base is thought to form a salt therein. While the ions may be located anywhere within the composition, the ions may be contained within the particle, discontinuous phase, continuous phase, or entire antifoam composition mentioned above. Preferably the salt added in a manner that provides stability to the above-mentioned particle in a discontinuous phase.

The composition may contain from 0 to 20 wt % of the base, preferably less than 15 wt %, more preferably less than 10 wt % of the base based upon the total weight of the composition. The amount of base may be 0, 0.001, 0.005, 0.01, 0.05, 0.1, 0.5, 1, 2, 5, 10, 15, and 20 wt %, including any and all ranges and subranges therein.

The composition of the present invention may contain a surfactant. While ionic, cationic, anionic, amphoteric, and nonionic surfactants are suitable, the most preferred surfactants are nonionic surfactants. Examples of such surfactants are ethoxylated nonylphenols. Further examples include a nonionic and/or an anionic surfactant. Suitable nonionics are ethylene oxide adducts such as a fatty alcohol ethoxylate and a nonylphenol ethoxylate and suitable anionics are alkylarylsulphonates such as sodium dodecylbenzenesulphonate. A wide range of surfactants can be used in the composition of the present invention. A typical listing of anionic, nonionic, cationic, ampholytic and zwitterionic classes, and species of these surfactants, is given for example in U.S. Pat. Nos. 3,664,961 and 6,916,777, which are hereby incorporated, in their entirety, herein by reference. Amphoteric surfactants are also described in detail in “Amphoteric Surfactants, Second Edition”, E. G. Lomax, Editor (published 1996, by Marcel Dekker, Inc.) McCutcheon's, Emulsifiers and Detergents, Annually published by M. C. Publishing Co., and Surface Active Agents and Detergents” (Vol. I and II by Schwartz, Perry and Berch), which are hereby incorporated, in their entirety, herein by reference.

While the surfactant may be located anywhere within the composition, the surfactant may be contained within the particle, discontinuous phase, continuous phase, or entire antifoam composition mentioned above. Preferably the surfactant is added in a manner that provides stability to the above-mentioned particle in a discontinuous phase. The composition may contain from 0 to 20 wt % of the surfactant, preferably less than 15 wt %, more preferably less than 10 wt % of the base based upon the total weight of the composition. The amount of surfactant may be 0, 0.001, 0.005, 0.01, 0.05, 0.1, 0.5, 1, 2, 5, 10, 15, and 20 wt %, including any and all ranges and subranges therein.

The composition may be required to be stable and/or perform at low temperatures. Therefore, the freezing and/or cloud point of the composition may be required to be reduced. Accordingly, the composition may include a freezing and/or cloud point suppressant. Any freezing and/or cloud point suppressant is sufficient. Preferable freezing and/or cloud point suppressants include glycols. Examples of glycols may be but is not limited to polyethylene glycols (PEG), as well as propylene and/or ethylene glycol. Further examples of solvent include alcohols and/or polyols. Examples of such alcohols include lower alkyl alcohols including isopropyl alcohol.

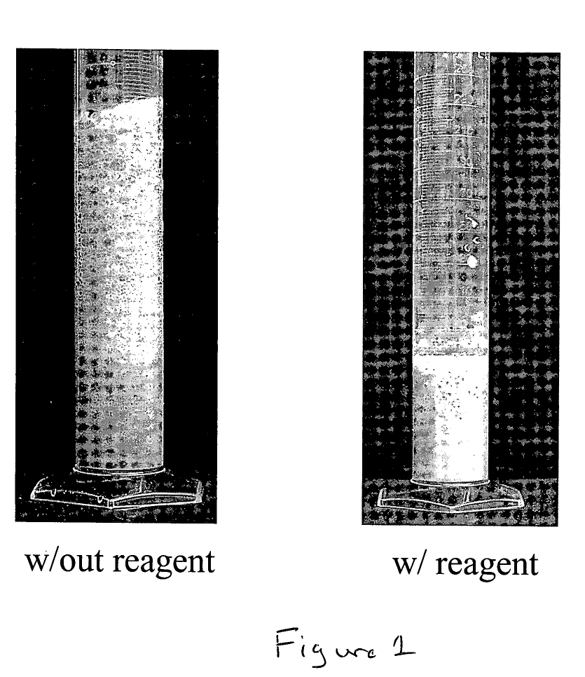

The composition of the present invention may be an antifoam for any foam-containing media. Accordingly, the antifoam composition may be added to a media being a partial and/or in whole foam. The foam may contain water, although it is not necessary. Accordingly, the present invention relates to a product of contacting the above-mentioned antifoam composition with a foam-containing media. Preferably, the foam state present in the media is reduced by at least 5% when the antifoam composition of the invention is contacted with the foam-containing media, especially when compared to a situation when the antifoam composition of the invention is not contacted with the foam-containing media. This is demonstrated clearly in FIG. 1 where the effect on the foam state is clearly a reduction when the foam-containing media is in contact with the antifoam composition. The foam state present in the media is reduced by at least 5, 10, 15, 20, 25, 30, 40, 50, 60, 70, 80, 90, 100, 125, 150, 175, 200, 300, 400, 500, 600, 700, 800, 900, and 1000%, including any and all ranges and subranges therein, when the antifoam composition of the invention is contacted with the foam-containing media, especially when compared to a situation when the antifoam composition of the invention is not contacted with the foam-containing media.

The foam-containing media can be of any pH, but preferably has a pH that is not more than about 7. The pH of the foam-containing media may be 1, 2, 3, 4, 5, 6, 7, 8, 9, 10, 11, 12, 13, and 14, including any and all ranges and subranges therebetween.

The foam-containing media may be any foam containing media. Preferably the foam-containing media is a by-product of mining and/or refining mineral, rock, and/or ore. Examples of such mining include mining phosphate rock and similar activities that utilize chemicals that may produce phosphoric acid and/or other phosphorus-containing compounds from the phosphate rock and/or ore. Another example of a utility of the present invention is towards any refining and/or beneficiation method/step which produces foam. Examples of such mining and/or refining and/or beneficiation of phosphate rock and/or ore is found in U.S. Pat. Nos. 6,149,013; 5,858,214; 5,500,193; 5,435,893; 4,737,273; and 4,828,811, which are hereby incorporated, in their entirety, herein by reference.

In addition and most preferably, the composition of the present invention may be utilized as an antifoam composition during the wet process production of phosphoric acid, such as orthophosphoric acid (H₃PO₄), from phosphate rock. More specifically, carbon dioxide is produced during extremely exothermic reaction conditions of the acidulation of phosphate rock by the addition of a strong acid such as sulfuric acid and/or hydrochloric acid (byproduct is calcium chloride) and/or nitric acid (by product is calcium nitrate). By products of this process include the production of gypsum, anhydrite gypsum, hydrates thereof such as the hemihydrate and/or dihydrate, and carbon dioxide. Since phosphate rock also contains fluorine, a by-product of this process step is a fluorine containing compound such as HF. Other mineral impurities of phosphate rock include calcium, iron, aluminum, magnesium and uranium, as well as organic matter.

Examples of phosphorus containing compounds are phosphoric acid, phosphates, phosphate salts, and mixtures and hydrates thereof.

The composition of the present invention may contain a foam-containing media. Preferably, the foam-containing media is at a pH of no greater than about 7 and also contains water and/or phosphate rock and/or by-products of refining phosphate rock. Phosphate rock is known to produce, in part, phosphoric acid and phosphates, such as those for use in fertilizers. A typical phosphate rock contains phosphates, magnesium and calcium salts, such as carbonates thereof. However, the amounts of these species may or may not always be present and may vary widely.

The present invention also relates to the product of adding the antifoam composition to a foam-containing media, so long as an effective amount of antifoam composition is added to reduce, inhibit, prevent, and/or retard foam production and/or the amount of foam present in the composition compared to those situation where the antifoam composition is not contacted with the foam-containing media.

The present invention is explained in more detail with the aid of the following embodiment examples.

### EXAMPLES

### Example 1

A composition was made by mixing the following:

| | | |
|---|---|---|
| 14 | parts | fatty acid (SYLFAT FA-1 from Arizona Chemical Company) |
| 2 | parts | NaOH (50%) |
| 86 | parts | water |

### Example 2

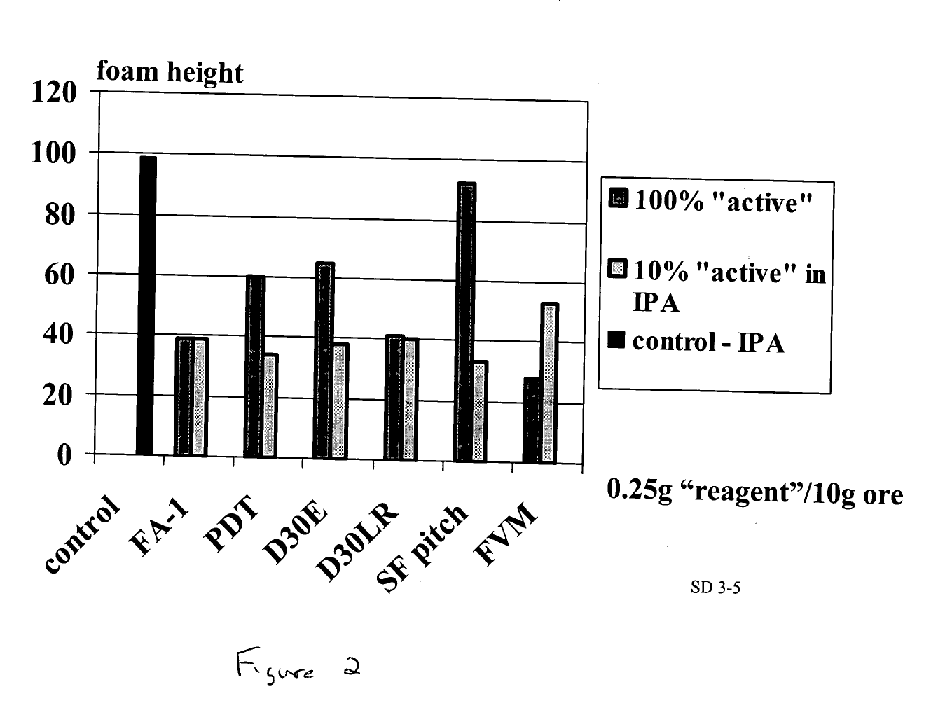

The antifoaming capacity of the composition containing SYLFAT FA-1 was tested according to the Anti-Foam Test Procedure at 45° C. below and compared to other similar tall oil products from Arizona Chemical Company at both pure and 10 wt % amounts in isopropanol. The results are shown in FIG. 2.

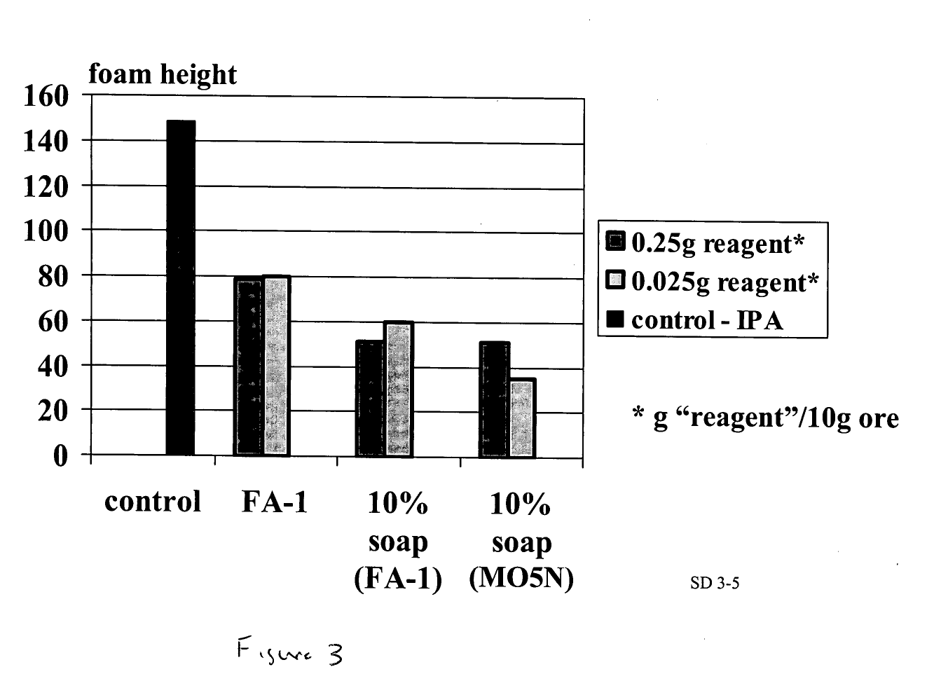

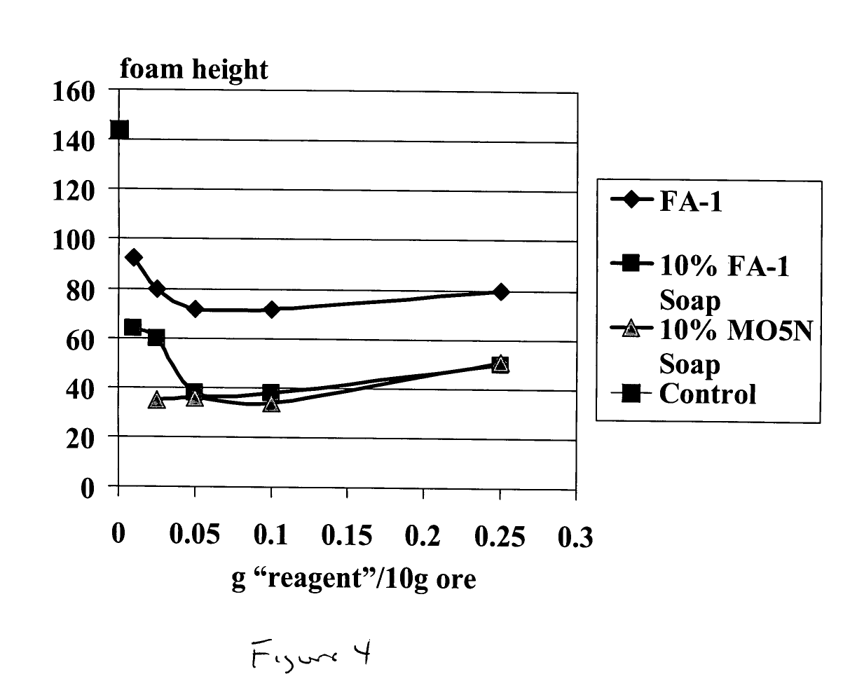

The antifoaming capacity of the SYLFAT FA-1 and MONOMER MO5N at different concentrations was tested when placed in 10 wt % amounts in isopropanol according to the Anti-Foam Test Procedure at 45° C. below and compared to other similar tall oil products from Arizona Chemical Company at both pure and 10 wt % amounts in isopropanol. The results are shown in FIGS. 3 and 4.

### Example 3

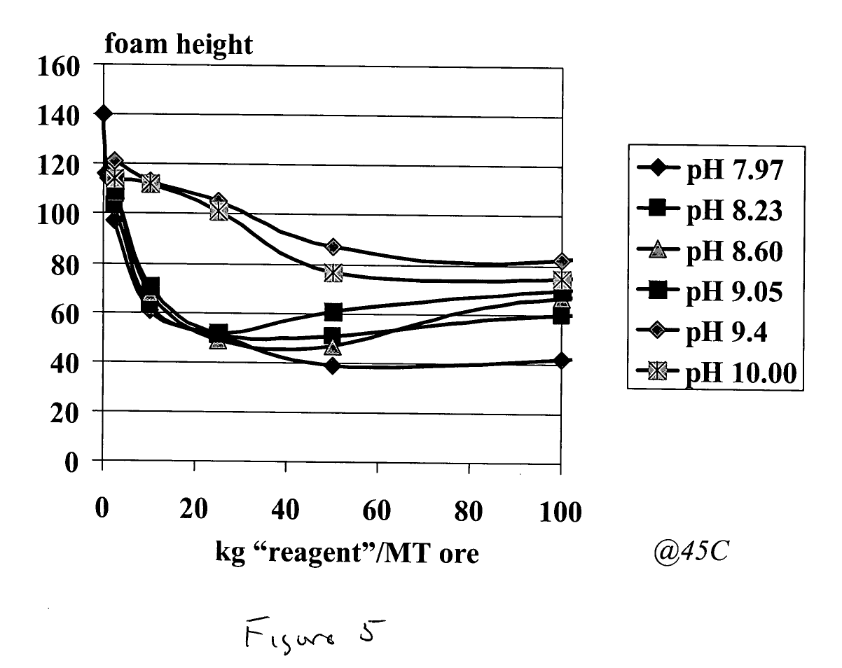

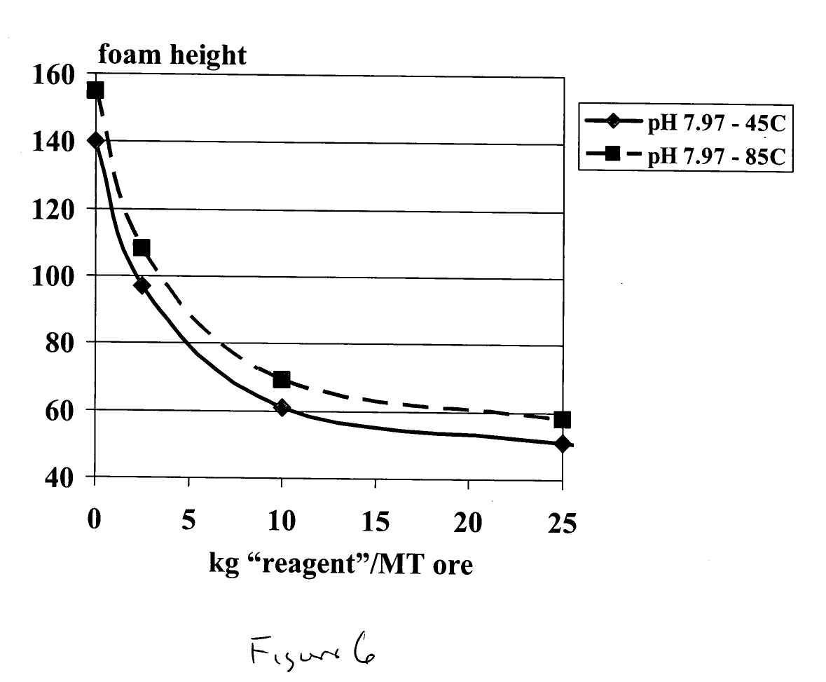

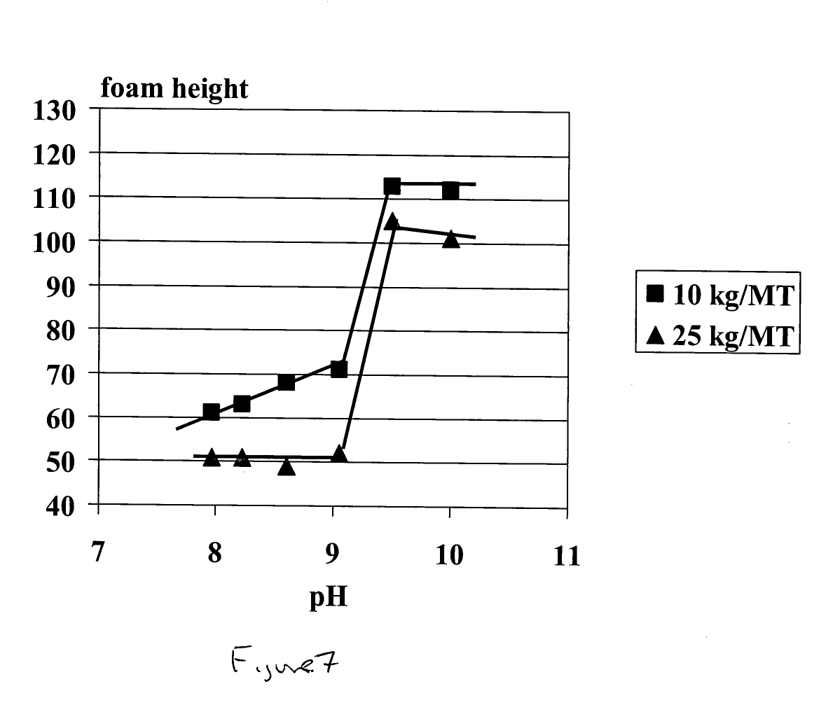

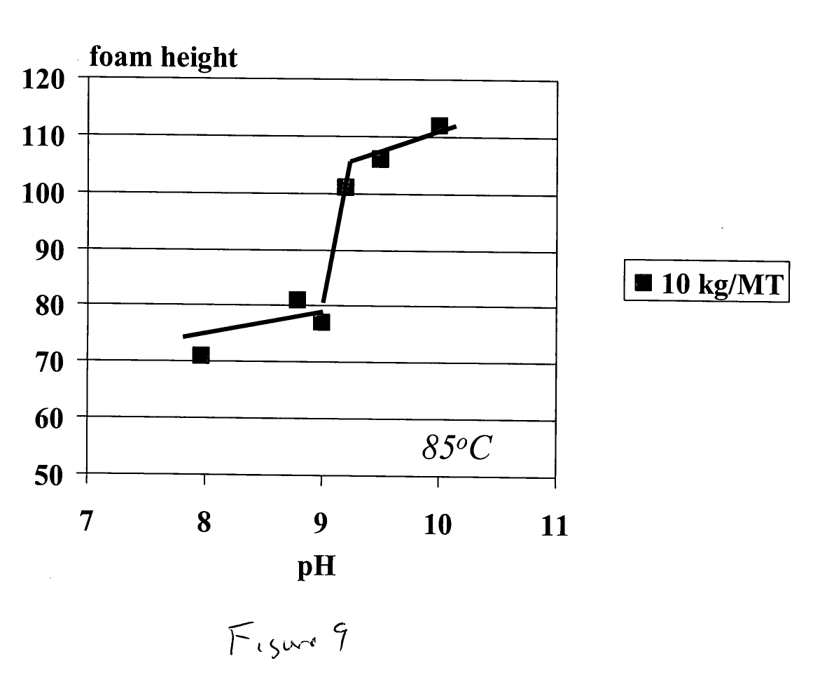

The antifoam capacity of the composition of Example 1 was tested at different pH's and different doses. The results in FIGS. 5, 7, and 9 and demonstrate that the composition works better at pH of from about 7.5 to about 9.5 at 45° C. and that this efficacy does not change when the temperature is raised to 85° C. The results of FIG. 6 demonstrate that the antifoam effect of the composition of Example is robust and very temperature insensitive (45° C. vs. 85° C.).

### Example 4

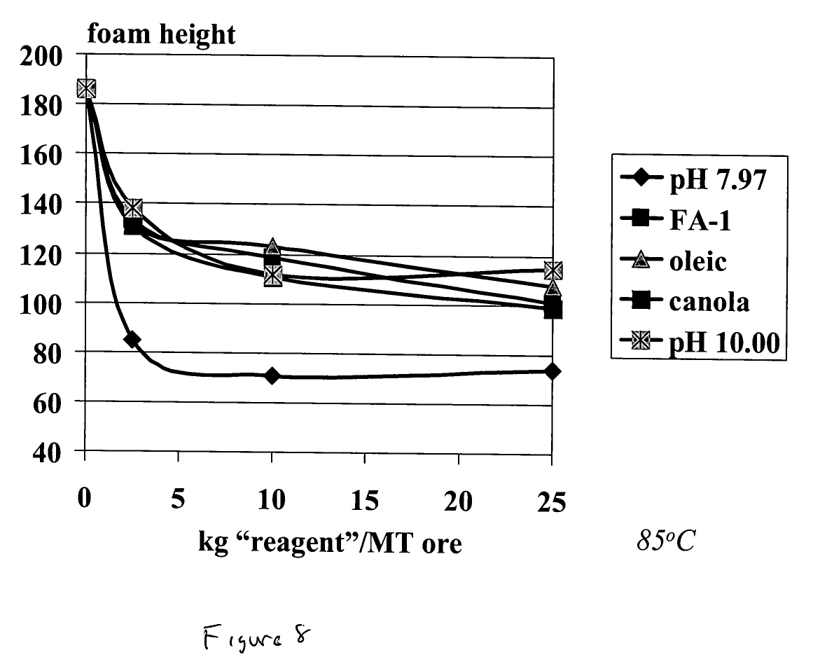

Samples were made with different actives other than SYLFAT FA-1, such as canola oil and oleic acid. The antifoam efficacy of Example 1 appears to be the best of all, especially at a pH of 7.97 where it is better than the SYLFAT FA-1 unaltered and/or at a pH of 10 (See FIG. 8).

Anti-Foam Test Procedure

1) Place stir bar (X style) into a 250 ml graduated cylinder with a flat bottom
2) Add 10 grams of ground ore/concentrate.
3) Bring level of water to 50 mls.
4) Place the cylinder on magnetic stir plate, start stirring action.
5) Mix until all ore wetted and dispersed.
6) Add specified amount of reagent to cylinder.
7) Add specified amount of acid to a small (60 ml) sepatory funnel secured above the cylinder. Place funnel tip so acid will flow down cylinder wall, and not through foam generated.
8) Open stopcock to add acid to the cylinder.
9) Observe and record maximum height of foam in cylinder.

As used throughout, ranges are used as a short hand for describing each and every value that is within the range, including all subranges therein.

Numerous modifications and variations on the present invention are possible in light of the above teachings. It is, therefore, to be understood that within the scope of the accompanying claims, the invention may be practiced otherwise than as specifically described herein.

The present application is related to U.S. patent application Ser. No. ______ filed on Aug. 8, 2005, and also claiming the benefit of priority under 35 USC §119(e) to U.S. Provisional Patent Application 60/599,459. U.S. patent application Ser. No. ______ filed on Aug. 8, 2005, is hereby incorporated, in its entirety, herein by reference.

All of the references, as well as their cited references, cited herein are hereby incorporated by reference with respect to relative portions related to the subject matter of the present invention and all of its embodiments

We claim:

1. A composition, comprising
the product of contacting
a) a mixture comprising
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture; and
not more than 60 wt % of unsaponifiable material based upon the total weight of the mixture;
with b) a partial or full foam comprising water at a pH that is less than 7;
wherein
a) may be pre-mixed with water to form a soap that is at least partially soluble therein and has a pH of no less than about 7; or
a) may be pre-mixed with an organic solvent to form a partial or full solution thereof.

2. The composition according to claim 1, wherein the distillation of natural oils is extracted from at least one member selected from the group consisting of resinous trees, vegetables, and tallow.

3. The composition according to claim 1, wherein a) is a partial or full dispersion, emulsion, suspension, or sol of tall oil pitch, tall oil, crude tail oil, monomer, distilled tall oil, or mixtures thereof.

4. The composition according to claim 1, wherein a) is pre-mixed with water to form a soap that is at least partially soluble therein and has a pH of no less than about 7.

5. The composition according to claim 1, wherein the pre-mixture of a) with water is in the form of a partial or full dispersion.

6. The composition according to claim 1, wherein a portion of the mixture a) are particles.

7. The composition according to claim 6, wherein the particles of a) have a size in at least one dimension ranging from 1 to 1000 nm.

8. The composition according to claim 1, wherein the mixture a) comprises
from 50 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture;
from 0.2 to 30 wt % of at least one rosin acid compound selected from the group consisting of natural resin-based acids obtained from residues of distillation of natural oils, amine carboxylates and ester and nitrile compounds of these acids based upon the total weight of the mixture; and
not more than 20 wt % of unsaponifiable material based upon the total weight of the mixture.

9. The composition according to claim 1, wherein a) comprises at least one ester, amide, amine carboxylate, and nitrile of at least one saturated or unsaturated, monocarboxylic aliphatic hydrocarbon having a linear, branched, and/or cyclic chain of from 8 and 24 carbon atoms.

10. The composition according to claim 1, wherein the mixture a) comprises
a combination of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof, and at least one rosin acid compound selected from the group consisting of natural resin-based acids obtained from residues of distillation of natural oils, amine carboxylates and ester and nitrile compounds of these acids at an amount ranging from 80 to 99.9 wt % based upon the total weight of the mixture; and
from 0.1 to 15 wt % of unsaponifiable material based upon the total weight of the mixture

11. The composition according to claim 1, wherein a) further comprises a sodium salt.

12. The composition according to claim 1, wherein a) is at a pH of from 7 to 10.

13. The composition according to claim 1, wherein a) is at a pH of from about 7.5 to about 9.5.

14. The composition according to claim 1, wherein b) further comprises an inorganic salt.

15. The composition according to claim 1, wherein b) further comprises a phosphorus-containing compound.

16. The composition according to claim 1, wherein b) further comprises phosphoric acid.

17. The composition according to claim 1, wherein a) is pre-mixed with an organic solvent to form a partial or full dispersion, suspension, sol, emulsion, or solution thereof.

18. The composition according to claim 17, wherein the organic solvent comprises a lower alkyl alcohol.

19. The composition according to claim 17, wherein the organic solvent comprises a poly(lower alkyl)ol.

20. The composition according to claim 17, wherein the pre-mixture of a) and organic solvent comprises from 0.1 to 99% of a poly(lower alkyl)ol, a lower alkyl alcohol, or mixture thereof.

21. The composition according to claim 1, wherein the premixture of a) and water or organic solvent or both comprises from 0.1 to 99 wt % of a).

22. The composition according to claim 1, wherein the premixture of a) and water or organic solvent or both comprises from 5 to 50 wt % of a).

23. The composition according to claim 1, further comprising isopropanol.

24. The composition according to claim 1, further comprising poly(lower alkyl) glycol.

25. The composition according to claim 1, further comprising polypropylene glycol.

26. A method of making the composition according to claim 1, comprising contacting a) with b).

27. The composition according to claim 1, further comprising gypsum.

28. The composition according to claim 1, further comprising a strong acid.

29. The composition according to claim 1, further comprising sulfuric acid.

30. The composition according to claim 1, wherein a) may be pre-mixed with an organic solvent to form a partial or full dispersion, suspension, sol, or emulsion thereof.

31. A method of inhibiting, reducing, and/or preventing the presence of foam in a media, comprising contacting
a) a mixture comprising
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the mixture;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the mixture; and
not more than 60 wt % of unsaponifiable material based upon the total weight of the mixture;
with b) a partial or full foam comprising water at a pH that is less than 7;
wherein a) may be pre-mixed with water to form a soap that is at least partially soluble therein and has a pH of no less than about 7 or a) may be pre-mixed with an organic solvent to form a partial or full dispersion, suspension, sol, emulsion, or solution thereof; and
wherein the amount of foam present in the media is reduced by at least 5% relative to the amount of foam present in the media when a) is not contacted with b).

32. The method according to claim 31, wherein b) further comprises comprises a phosphorus-containing compound.

33. The method according to claim 31, wherein b) further comprises phosphoric acid.

34. The method according to claim 33, further comprising refining phosphorus-containing rock.

35. The method according to claim 34, wherein the contacting and the refining are performed concurrently.

36. A composition, comprising
a mixture comprising
from 0.1 to 99.9 wt % of at least one saturated or unsaturated, monocarboxylic aliphatic hydrocarbon or derivative thereof having a linear, branched, and/or cyclic chain of from 8 and 24 carbon atoms, a dimer thereof, a trimer thereof, or mixtures thereof based upon the total weight of the particle;
from 0.1 to 99.9 wt % of at least one rosin acid compound selected from the group consisting of natural resin-based acids obtained from residues of distillation of natural oils, amine carboxylates and ester and nitrile compounds of these acids based upon the total weight of the particle; and
not more than 60 wt % of unsaponifiable material based upon the total weight of the particle;
a phosphorus-containing compound; and
water.

37. The composition according to claim 36, wherein the composition is a partial or full dispersion, suspension, sol, emulsion, or mixtures thereof

38. The composition according to claim 36, wherein the composition is a partial foam.

39. The composition according to claim 36, wherein the phosphorus-containing compound is at least one member selected from the group consisting of phosphoric acid and phosphoric rock.

40. The composition according to claim 36, further comprising gypsum.

41. The composition according to claim 36, further comprising a strong acid.

42. The composition according to claim 36, further comprising sulfuric acid.
